(19) United States
(12) Patent Application Publication
(10) Pub. No.: US 2023/0176574 A1
(43) Pub. Date: Jun. 8, 2023

(54) System and Method For Utilizing a Health Monitoring Device to Detect a Health Emergency to Activate an Autopilot Feature

(71) Applicants: John Paul Beitler, JR., Chicago, IL (US); John Paul Beitler, III, Chicago, IL (US)

(72) Inventors: John Paul Beitler, JR., Chicago, IL (US); John Paul Beitler, III, Chicago, IL (US)

(21) Appl. No.: 17/544,154

(22) Filed: Dec. 7, 2021

(51) Int. Cl. G05D 1/00; B60W 40/08; G08B 21/04

(52) U.S. Cl. CPC G05D 1/0061; G05D 1/0088; B60W 40/08; G08B 21/0453; B60W 2040/0818; B60W 2040/0872; B60W 2040/089

(57) ABSTRACT

A system including a software application for detecting the health status of a person operating a vehicle, aircraft or machine, and for evaluating whether said operator has become physically incapable of operating the vehicle and for thereafter initiating the auto-control technology present in the vehicle, aircraft or machine. The system includes a health monitoring device worn by an operator, a sensor located in the health monitoring device capable of sending a signal, a storage for maintaining vital health statistics, a health monitoring system capable of comparing vital health statistics and a control system capable of receiving signals and activating the auto-control technology.

### FIELD OF THE INVENTION

The present invention relates to a health monitoring software application for detecting the health status of a person operating a vehicle, aircraft or machine. More particularly, the present invention relates to a system that detects when an operator of the vehicle, aircraft or machine has become incapable of operating the vehicle. The system is designed to work in connection with a control system having auto-control technology to determine when the operator of the vehicle, aircraft or machine may be experiencing a health event that would render the operator unable to control the vehicle and initiate an auto-control system in the event of an emergency.

### BACKGROUND OF THE INVENTION

There is a need for a method and apparatus for monitoring the vital statistics of a person while operating equipment, machinery, vehicles or aircraft to determine whether the individual has become incapacitated. Upon detecting an emergency situation, such as a medical emergency, the present invention operates to yield control of the operation to an automated control system which is programmed to guide the equipment, machine, vehicle or aircraft to a safe shut-down or termination of the operation without the action of the incapacitated operator.

There is currently a large industry for wearable devices that can monitor individual health information. These wearable devices can track many different health statistics such as a person's heart rate, vital signs, blood oxygen and stress levels. For example, Apple, Garmin, and Fitbit each make wearable products in the form of wristwatches that can track sleep-quality, heart rate, and blood-oxygen saturation levels.

There is also a growing industry for auto-control technology for different types of vehicles such as airplanes, cars, trucks, watercraft and trains. Such technology has become extremely important to maneuver and guide the vehicle without the need for an operator. In the automotive industry, for example, there are semi-autonomous driving technology (often called “auto-pilot”) which is designed to safely control the automobile without the input of an operator. There is also driver support technology which reduces the workload on an operator such as cruise control, lane-keeping assistance and hands-free capability. There are autonomous systems that actually operate to control and maneuver the automobile. However, the systems do not detect if an operator has experienced a medical emergency.

There exists autonomous technology used in the aviation industry. For example, aircraft have been programmed to fly along certain programmed flight paths, maintain predetermined altitudes, and even proceed with landing the aircraft.

In the aviation industry, many companies are implementing emergency auto-landing technology. For example, Garmin has developed a button that works in connection with an automatic-landing technology and may be pressed by the pilot or passengers during an emergency. Similarly, Tesla has begun implementing full self-driving technology into many of its cars. Once again, these systems require user activation and do not detect if an operator has experienced a medical emergency. These technological developments are important to prevent substantial injuries to both the passengers of the vehicles, as well as any individuals and/or property who may fall within the unknown path of a driverless vehicle in motion.

While great strides have been made in the field of automatic vehicular operating systems, the above referenced examples each have a common defect. Each system requires human interaction to initiate the functioning of the auto-control technology. The requirement of human interaction is an impediment where the operator has experienced an emergency health issue and becomes incapacitated due to the health emergency.

The health-monitoring auto-control notification technology can play an important role in emergency situations such as where a vehicle operator suddenly experiences a health emergency. Health monitoring technology can track when a serious health emergency occurs by detecting relevant information such as when a user's heart rate suddenly decreases, blood pressure, blood oxygen level and the like.

The current technology has not been paired with a system to detect when an operator experiences a sudden health emergency and safely implements an auto-control feature to safely bring the equipment to rest. The prior technology has therefore failed to address the need for providing a system which automatically detects when a person operating a vehicle, aircraft or machine has become incapacitated, and accordingly signals the auto-control technology to immediately begin functioning to control the vehicle, aircraft or machine.

Thus, there is a need for implementing health-monitoring devices and auto-control systems to create a system that could detect sudden emergency situations and consequently initiate the function of the auto-control system. There are numerous situations where such technology is needed. For example, while the available emergency auto-control feature expressed above may suffice if there are others in the vicinity who are not incapacitated, there is a need for a system that detects if an operator has become incapacitated and implements an auto-control technology to guide the vehicle aircraft or machine to safety. There is a need to also address situations where a solo operator has suddenly become physically unable to operate the vehicle.

### SUMMARY OF THE INVENTION

The present invention relates to a software application that may be installed or downloaded to a health-monitoring device which is configured to work in connection with a variety of monitoring software to detect when a vehicle operator is unable to operate the vehicle. The system operates to activate a control system working in connection with the vehicle's auto-control system which implements an auto-control technology to function in a manner to control the vehicle to safety. The specification will use the words vehicle, aircraft, machinery and equipment interchangeability. It should be understood that when the terms vehicle, aircraft, machine or equipment are used in this disclosure, it will refer to the individual vehicle, aircraft, machine or equipment referred to, and to the group of all vehicles, aircraft, machinery or equipment as well.

The present invention utilizes an application which may be downloaded to a device capable of using software that works in connection with a device capable of monitoring a user's health. The application is intended to work in connection with a plurality of health monitoring software to quickly detect when a vehicle operator experiences sudden and unanticipated debilitating physical impediments. After detecting when an emergency event arises, the application initiates the sending of an emergency signal to a control system. When the control system receives the emergency signal, the control system operates a series of checks and, if necessary, activates an auto-control system incorporated into the given vehicle. The control system continues to operate the auto-control technology to begin functioning while human operation is unavailable until an override proceeding is implemented by the user.

In one embodiment, the present invention includes a wearable health monitoring device that implements a health monitoring software capable of monitoring a users' vital health statistics, recording various health statistics of the user, and sending a signal to a control system when an emergency health condition is detected.

In another embodiment, the present invention includes a software application that is capable of operating the control system in association with health monitoring software programs to detect when the user is experiencing a sudden and serious health complication and is also able to evaluate and determine the immediacy of a user's health issue in relation to the vehicle's current route.

In another embodiment of the present invention the control system is capable of downloading software that interacts with the wearable health monitoring device, capable of receiving a signal indicating an emergency event, and capable of operating an auto-control system of a vehicle.

In yet another embodiment of the present invention, the control system monitor is capable of electronically sharing information with vehicle operator.

In a further embodiment of the present invention, the control system and health monitoring system are capable of comparing the vital health signal with a stored vital health statistic to determine if the vital health signal complies with the stored vital health statistic to determine an emergency event and generating an alarm if the vital health signal indicates an emergency event.

The present invention determines the existence of an emergency event based on the comparison of the vital health signal and the stored statistics and if the vital heath signals indicate a medical emergency, whereby the control system and health monitoring system activate emergency auto control functions to safely guide the aircraft to a safe landing, the automobile to a safe resting place or safely shut down any equipment.

Other objects and advantages of the invention will become apparent upon reading the following detailed description and reference to the attached drawings.

### BRIEF DESCRIPTION OF THE DRAWINGS

FIG. 1 depicts a view of a preferred wearable health monitoring device.

FIG. 2 depicts a view of the preferred wearable health monitoring device that depicts the various systems.

FIG. 3 is a depiction of the control system within a vehicle comprising auto-control technology.

FIG. 4 is a depiction of the preferred wearable health monitoring device interacting with the control system by sending a signal from the health monitoring device to the control system in an aircraft.

FIG. 5 is a depiction of the wearable health monitoring device detecting a sudden health issue of a vehicle operator.

FIG. 6 is a flow chart of the steps that comprise the operation of the health monitoring auto-control system.

### DETAILED DESCRIPTION OF THE PREFERRED EMBODIMENTS OF THE INVENTION

An illustration of the present invention will be described with reference to the accompanying drawings. The following description of the examples of the present invention is intended to be for illustrative purposes. Therefore, it should be understood that the preferred system, apparatus and method set forth below are exemplary and that there are other apparatus and systems that can be utilized without departing from the spirit of the invention.

The preferred embodiment of the present invention incorporates a monitoring device that operates to monitor the vital health signals of a vehicle operator, detect sudden health emergencies or physical impairments which may impact the ability of the vehicle operator to the vehicle, and notify a control system of the emergency event and operates to activate an auto-control system to assume operation of the vehicle when an emergency event occurs.

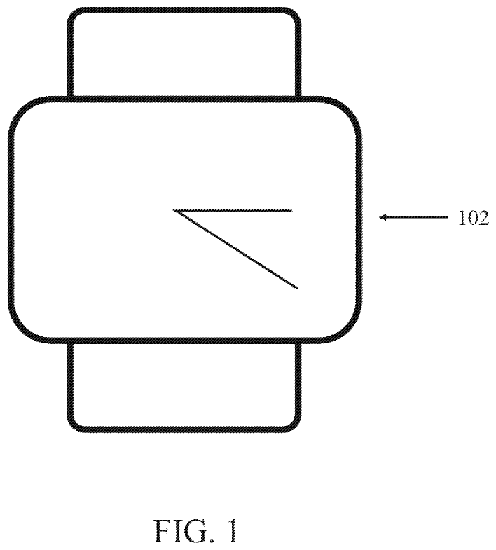

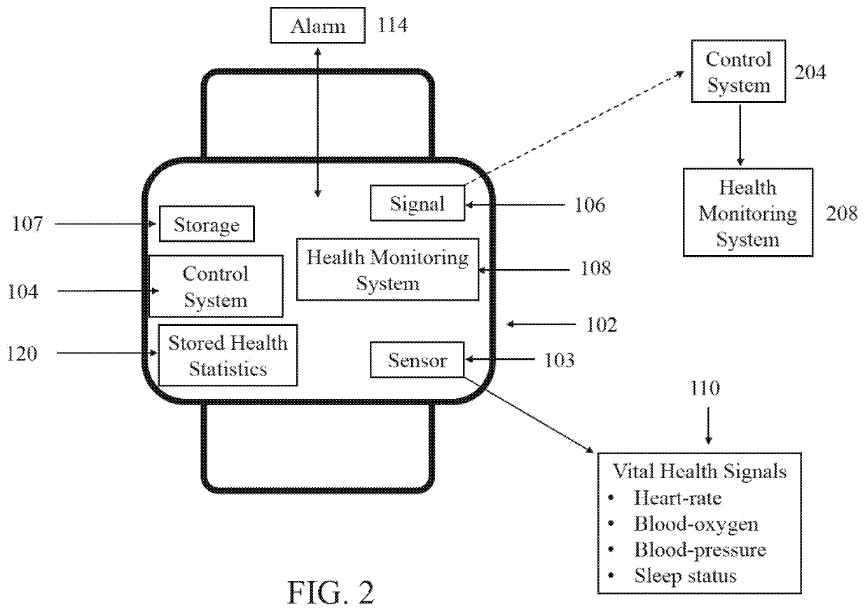

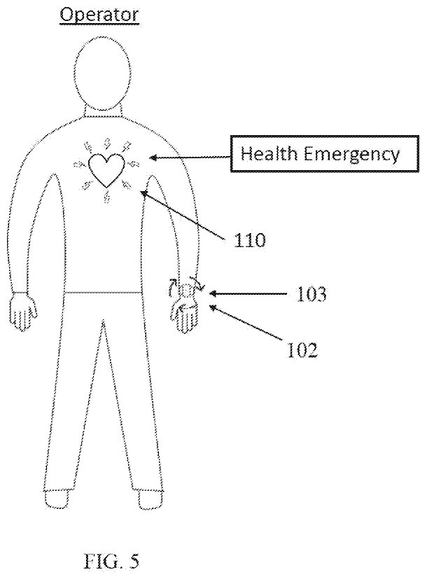

As shown in FIGS. 1, 2 and 3, the system of the present invention utilizes a wearable health monitoring device 102 capable of sending a signal 106 to either a control system 204 that may be a software application or other type of software either within the monitoring device 102 or the control system 204 that may be located within an aircraft, automobile or equipment 200. The monitoring device 102 also includes a sensor 103 that receives vital health signals 110 from the user that may be stored 107 in health monitoring device 102, and a control system 204 with an auto-control feature 218. The vital health signals 110 can be stored 107 in either the health monitoring device 102 or the separate control system 204. The function of the system will not change depending on the whether the vital health signals 110 are stored 107. As shown in FIG. 5, the wearable health monitoring device 102 may be worn on the wrist of the operator but may be worn on various other parts of the body, such as a finger, upper arm, or torso while the user is operating a vehicle. Alternatively, the health monitoring device 102 could be configured as an integrated chip placed within the body of the operator. The chip may comprise an identifying integrated circuit device or RFID transponder encased in silicate glass and implanted in the body of a human being. This type of subdermal implant usually contains a unique ID number that can be linked to information contained in an external database, such as personal identification, vital health information, medical history, medications, allergies, and contact information. It should be appreciated that the chip will have all the features and functions of the heath monitoring device 102 described in the detailed description of the invention.

The wearable health monitoring device 102, as shown in FIGS. 1 2, 4 and 5, could monitor a user's vital health signals 110 which may include one or more of the following vital health signals as heart rate, blood pressure, and/or blood-oxygen saturation levels. The health monitoring device 102 includes sensors 103 for detecting each of the user's vital health signals 110 and storing 107 the vital health signals 110 based upon the signal received from the sensors 103. The health monitoring device 102 may include stored information or health statistics 120 related to predetermined levels of acceptable vital health signals. The health monitoring device 102 may include a control system 104 application or software that operates to compare the vital health signal 110 received from the user with the stored information 120 on the health monitoring device. The control system 104 operates to monitor the vital health signals 110 to ensure that the vital health signals 110 of the operator are maintained within the parameters established in the stored health information 120. The health monitoring device 102 includes sensors 103 which depict a medical emergency such as a heart attack as depicted in FIG. 5. The sensor 103 may detect the user's vital health signals 110 such as heartbeat and stores 107 the vital health signals 110 based upon the signal received from the sensors 103. The health monitoring device 102 compares the stored information or health statistics 120 with the stored 107 vital heath statistics 110 received form the sensor 103. Using an algorithm, the health monitoring system 108 of the control system 104 compares vital heath signals 110 of the heart rate and compares the value with a predetermined levels of heart rate stored as a stored health statistic 120. The algorithm of the health monitoring system 108 analyzes the heart rate to determine if it falls within what is considered an acceptable vital health signal 110. The health monitoring device 102 may include a control system 104 application or software that operates to compare the vital health signal with the stored health statistics 120.

The control system 104 operates to coordinate the signals that are sent to a control system 204. For example, the control system 104 application may operate to determine if an emergency event is occurring and send a warning signal to the control system 204. The control system 104 application could also send information to the control system 204 such as the stored health status 120, the vital health signals 110 interpreted by the sensor 103 or any health monitoring signal. Alternatively, the control system application 104 may send the vital health signal 110 to the control system 204 located in an aircraft, automobile or other type of equipment 200. In the alternative embodiment the control system 204 located in the aircraft, automobile or other type of equipment 200 may monitor the vital health signals 110 to ensure that the vital health signals 110 of the operator are maintained within the parameters established in the stored health information 120.

One method of monitoring the health status of the user involves the health monitoring system 108 which operates to compare the vital health signals 110 with the stored health statistics 120. The health monitoring system 108 may also detect an operator's sudden movements, such as when an operator's arm suddenly drops. The stored health statistics 120 are provided with health values. If the health monitoring system 108 detects a vital health signal that is not within the predetermined range of acceptable values for the stored health statistics 120, the health monitoring system 120 will generate a health alert signal. If the control system 104 detects an abnormality in the vital health signals 110, the health monitoring system 108 will activate an alarm 114 and emergency signal 106. The alarm 114, which may be audible, operates to notify the user of a health issue. In addition, the device 102 operates to send a signal 106 to the health monitoring system 208 of the control system 204 indicating that there is a potential problem.

While in the above systems, such as the health monitoring system 108, the stored health statistics 120, alarm 114, storage 107, and health monitoring system 108 are shown as being located in the health monitoring device 102, it should be appreciated that one or more of the systems may be located in the control system 204 without departing form the spirit of the invention.

The health monitoring device 102 is also capable of having a health issue detecting software that works in connection with the health monitoring system 108 on the device to determine, based on information collected by the health monitoring software, when a user is experiencing a health issue which may interfere with the vehicle operator's ability to operate the vehicle.

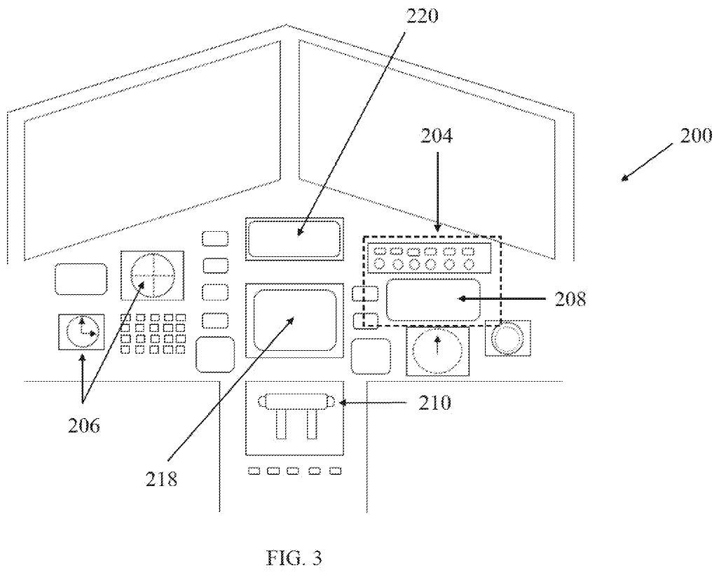

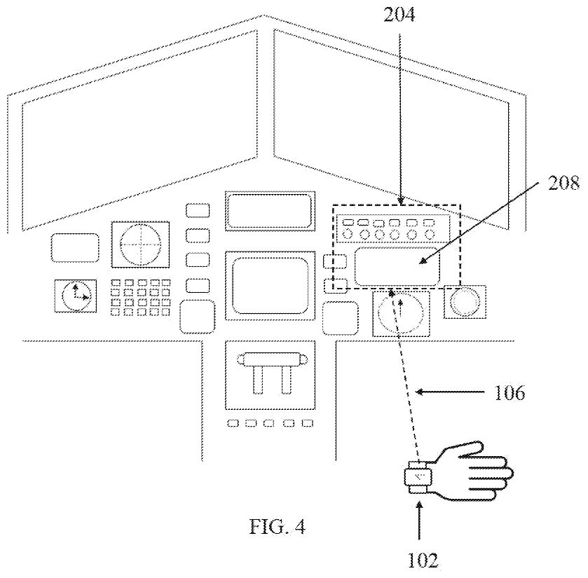

The health monitoring system 108 may be located in the monitoring device 102 or it could be located in the control system 204 of an aircraft 200 as shown in FIGS. 3 and 4. The health monitoring system 208, therefore, may be part of the operation control system 204 and may work in connection with the health monitoring system 108 on the wearable health monitoring device 102 to detect when a health issue has occurred based on the information collected from the health monitoring system 108. The health monitoring system 108 is shown on the health monitoring device 102, however it could be located within the control system 204. As shown in FIG. 4, the health monitoring device 102 may be in communication with a control system 204 and the health monitoring system 208 located in the aircraft though a signal 106.

As shown in FIGS. 3, 4 and 6, a control system 200 includes the operating controls of a vehicle, aircraft or machine. The control system 200 includes a control system 204, gauges 206, health monitoring system 208, manual controls 210, automatic controls 220 and emergency operation automatic controls 218. The control system 204 and health monitoring system 208 may be identical to the control system 104 and health monitoring system 108 identified above with the exception that the control system 204 and health monitoring system 208 are located in the aircraft, automobile or other type of equipment rather than in the device 102. It is contemplated that the device could contain the control system 104 and health monitoring system 108 and the aircraft, automobile or other type of equipment could contain the control system 204 and health monitoring system 208 as well as a backup system to ensure that any medical emergency is detected and acted upon.

When the health monitoring system detects that the vehicle operator has experienced a health issue, the health monitoring system 108 sends a signal 106 to the control system 204 which notifies the health monitoring system 208 of the health issue. Alternatively, the health monitoring system 208 may be present in the control system 204 and may recognize when a health issue has occurred based on health information communicated by the health monitoring system 108 using the wearable health monitoring device 102. The health issue detecting software present within either the control system 204 or the wearable health monitoring device 102 has the capability of evaluating and determining the immediacy of the health issue in relation to the vehicle's current stage of travel. If the health monitoring system 108 detects an immediate issue, such as when a vehicle operator is experiencing a debilitating health issue during operation of an airplane, the control system 204 and heath monitoring system 208 will receive notice of the health issue signal 106, and work in connection with the auto-control technology 220 to carry out the appropriate course of action such as land the aircraft, stop the operation of the machine or direct the vehicle to pull over or divert to a hospital or as otherwise directed by the control system 204. The system may have various gauges 206 to display the status of the operator as well as the status of the aircraft, automobile or other type of equipment.

For example, an operator may be piloting an aircraft and wearing the health monitoring device 102. The monitoring device includes a sensor 103 that monitors the operator's vital health signals 110. The operator's vital health signals 110 are sent to the health monitoring system 108 to be compared to the stored value health statistics 120 to determine if the vital health signals of the operator fall within a predetermined level of what would fall within a “normal” range of vital signals. If the control system 104 is located in the device 102, the health monitoring device 108 operates to determine if there is a medical emergency based upon the vital health signals 110. If the control system 204 is located in the aircraft, the health monitoring system 208 operates to determine if there is a medical emergency based upon the vital health signals 110 sent form the device 102 via signal 106. The operator can pilot the aircraft by managing the manual controls 210 or the auto-controls 218 and 220 of the aircraft as shown in FIG. 3. The control monitoring system 204 includes a health monitoring system 208 which includes software for detecting emergency signals 106 from the health monitoring device 102.

The health monitoring device 102 is capable of sensing when an emergency event of the operator occurs. Thus, the health monitoring system 108 includes software to monitor the vital health signals 110 of the operator as compared to the stored health statistics 120 to detect whether the vital health signals 110 of the operator conform to the predetermined values of acceptable stored vital health statistics 120. The health monitoring system 108 will function to send an alert signal 106 when an issue is detected by the health monitoring system 108. The alert signal could be an audible alarm 114 as well as a wireless system signal 106 to indicate that there is an emergency situation. Importantly, the signal 106 is sent to the control system 204 which receives the emergency signal 106. The control system 204 in an aircraft, automobile or other type of equipment includes an emergency health issue implementation software in the control system 204 that may be activated by the health monitoring system 208.

The health monitoring system 208 of FIGS. 3 and 4 may operate in the same manner as the health monitoring system 108 described above with respect to the health monitoring system 108 located in the health monitoring device 102. The health monitoring system 208 may monitor an operator's vital health signals 110 that are sent from the health monitoring device 102 to the health monitoring system 208 to be compared to the stored value health statistics 120 located in the health monitoring system 208 to determine if the vital health signals of the operator fall within a predetermined level of what would fall within a “normal” range of vital signals. The health monitoring system 208 operates to determine if there is a medical emergency based upon the vital health signals 110. Thus, the health monitoring system 208 includes software to monitor the vital health signals 110 of the operator as compared to the stored health statistics 120 to detect whether the vital health signals 110 of the operator conform to the predetermined values of acceptable stored vital health statistics 120. The health monitoring system 208 may function to send an alert signal through the gauges 206 or through and audio alarm (not shown) when an issue is detected by the health monitoring system 208. The alert signal could be an audible alarm to indicate that there is an emergency situation. The gauges 206 may also indicate that there is a medical emergency.

The health monitoring system 208 operates to take the appropriate steps to ensure that an actual emergency situation has occurred. For example, the control system 204 may implement an audio alarm and an override button to stop the control system 204 from implementing an emergency response action. The gauges 206 may also indicate that there may be a medical emergency permitting the operator to override the control system 204 if there is not an actual medical emergency. If no override proceeding is implemented, then the control system 204 implements an emergency procedure.

The control system 204 operates to engage an emergency proceeding to disable the manual controls 210 and any preactivated auto control feature 220. The control system 204 will calculate the optimal steps to implementing the auto control feature 220 or an emergency auto control 218 and bring the aircraft to a safe landing. The control system 204 will include the necessary programs to activate the automatic control feature 220 or the emergency auto control 218 to bring the vehicle, aircraft or equipment to a safe resting state. In an alternative embodiment, the control system 204 may be guided by a remote third party not located in the vehicle, aircraft or equipment in the event of a medical emergency.

The control system 204 also monitors the crucial operating phase when the health monitoring system 208 detects a potential health event. If a potential health event is detected, the control system 204 will operate in connection with the health monitoring system 208 to notify the vehicle operator that the health issue has been detected, and to request a status update from the vehicle operator. The vehicle operator may have the option to respond to the status update by selecting the option confirming that no action is necessary at the time. The health monitoring system 208 could be able to identify and initiate the proper procedure based on the vehicle operator's response to the emergency notification. When the vehicle operator selects the “no action needed” option, this action may notify the control system 204 that no further action is necessary with regard to the auto-control 220, therefore ending the auto-control process. If the vehicle operator does not respond to the control system's 204 notification within the required duration, the health monitoring system 208 could detect the operator's failure to respond, and thereafter signal the control system 204 to implement the emergency procedure as directed by the control system 204.

The control system 204 may include a monitor that is cable of producing a visual or auditory alert when the heath monitoring system 108 has detected that the vehicle operator is experiencing a health issue which may affect the vehicle operator's ability to operate the vehicle. The monitor and gauges 206 could provide an emergency notification signal to the vehicle operator requesting the vehicle operator select an option indicating whether the vehicle operator is in good status.

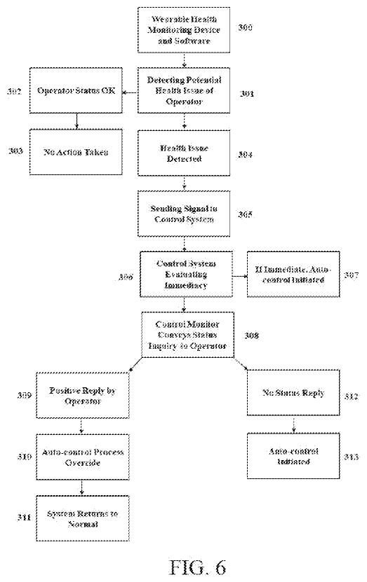

FIG. 6 depicts the operation of the software controls of the present invention. The first step includes an operator wearing a health monitoring device 300 to monitor the vital statistics of an operator of an aircraft, vehicle or equipment. The monitoring device 300 has the ability to detect a potential health issue 301 of the operator which causes an emergency situation. The software for detecting the potential health issue 301 may reside on the monitoring device 102 as a health monitoring system 108, control system 104 and/or within a control system 204 of the aircraft, vehicle or equipment. As the health monitoring system 208 or control system 104/204, the step of detecting a potential health issue 301 has two decision steps. The first decision determines that the operator's health status has not created an emergency situation 302. In that situation, the system takes no emergency action 303. However, if an emergency health issue is detected 304, a signal is sent to the control system 305. The control system 305 will determine the immediacy 306 of the emergency health situation. If an emergency health situation is detected, 307, an auto control feature is activated which operates the aircraft, vehicle or equipment to a safe conclusion of operation. The control system evaluation of the immediacy 306 may provide a status inquiry to the operator to determine the level of risk 308. A positive response from the operator 309 will initiate an auto control process override 310 which returns the operating system to normal operation 311. If there is no reply from the operator 312, the auto control feature is implemented 313.

While specific combinations of elements are disclosed in specific embodiments, it should be understood that any combination of the different features may be utilized in the present invention.

The foregoing disclosure and description of the invention are illustrating and explanatory thereof, and various changes in the size, shape and materials as well as in the details of illustrated construction may be changed without departing from the spirit of the invention.

It is understood that the invention is not limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A health monitoring system when an operator is using a mechanical devise comprising:
a health monitoring device positioned on the body of an operator;
a sensor located in the health monitoring device capable of sensing a vital health signal of the operator and generating a vital health signal;
a storage for maintaining stored vital health statistics where in the vital health statistics are assigned a predetermined value for vital health statistics indicating an emergency event;
a health monitoring system capable of comparing the vital health signal with the stored predetermined value for vital health statistics to determine if the vital health signal complies with the stored vital health statistics to determine an emergency event and generating an alarm signal from the health monitoring system when the vital health signal indicates an emergency event;
a control system which has a health monitoring system whereupon receiving the alarm signal activates an emergency system and alerts the appropriate authorities of the emergency;
the emergency system operates to activate an autopilot system that operates to an automated termination process.

2. The health monitoring system of claim 1 wherein the vital health signals are selected from the group of health metrics comprising of a heart rate, a blood-oxygen level and a blood pressure.

3. The health monitoring system of claim 2 wherein the health warning signal is a wireless signal.

4. The health monitoring system of claim 2 further comprising an audible alarm signal generated upon the detection on an emergency event.

5. The health monitoring system of claim 2 wherein the mechanical device is an aircraft.

6. The health monitoring system of claim 5 wherein the autopilot system operates to maneuver the aircraft to the nearest airport to land the aircraft safely.

7. The health monitoring system of claim 2 wherein the mechanical device is an automobile.

8. The health monitoring system of claim 7 wherein the autopilot system operates to maneuver the automobile to a safe stop without the input of the operator.

9. The health monitoring system of claim 2 wherein the mechanical device is a watercraft.

10. The health monitoring system of claim 9 wherein the autopilot system operates to maneuver the watercraft to a safe stop without the input of the operator.

11. A method for monitoring the health of an operator of equipment of the steps comprising:
positioning a health monitoring device on the body of an operator;
sensing a vital health signal of the operator by a vital health sensor within the health monitoring device;
generating a vital health signal value from the sensing of the vital health signal of the operator;
storing a stored vital health statistic within a health monitoring system having predetermined emergency value for the vital health statistics that indicate an emergency event;
comparing the vital health signal value with the stored vital health statistic;
determining if the vital health signal is a predetermined range of the predetermined emergency value for the vital health statistic and if the vital health signal is with the predetermined range generating an emergency signal;
monitoring the existence of an emergency signal within a control system to detect the emergency signal;
activating an emergency autopilot feature upon detecting the emergency signal; and
implementing an automated termination process upon the activation of the emergency autopilot feature;
a control system included in a mechanical system wherein the control system includes an auto-control feature to operate the mechanical system without the operator;
generating a health warning signal that is activated upon an alarm signal and generating an emergency communication to the control system;
an emergency system operating is part of the control system which receives the health warning signal and activates an autopilot system;
implicating an autopilot system operating as part of the control system that operates to an automated termination process.

12. The method of monitoring the health of an operator of equipment of claim 11, wherein the vital health signal is a signal selected from the group comprising of heart rate, blood oxygen level and blood pressure.

13. The method of monitoring the health of an operator of equipment of claim 12, wherein the health warning signal is a wireless communication.

14. The method of monitoring the health of an operator of equipment of claim 12, further comprising the step of generating an audible alarm upon generating the health warning signal.

15. The method of monitoring the health of an operator of equipment of claim 12, wherein the mechanical system is an aircraft.

16. The method of monitoring the health of an operator of equipment of claim 15, further comprising the step of landing the aircraft using the autopilot system.

17. The method of monitoring the health of an operator of equipment of claim 12, wherein the mechanical system is an automobile.

18. The method of monitoring the health of an operator of equipment of claim 17, further comprising the step of guiding the automobile to a safe stop using the autopilot system.

19. The health monitoring system of claim 12 wherein the mechanical device is a watercraft.

20. The health monitoring system of claim 19 wherein the autopilot system operates to maneuver the watercraft to a safe stop without the input of the operator.
